(19) United States
(12) Patent Application Publication
(10) Pub. No.: US 2014/0157064 A1
(43) Pub. Date: Jun. 5, 2014

(54) SYSTEM AND METHOD FOR TESTING SUB-SERVERS THROUGH PLURALITY OF TEST PHASES

(71) Applicants: INVENTEC (PUDONG) TECHNOLOGY CORPORATION, (US); INVENTEC CORPORATION, Taipei (TW)

(72) Inventor: Jie CUI, Shanghai (CN)

(73) Assignees: INVENTEC CORPORATION, Taipei (TW); INVENTEC (PUDONG) TECHNOLOGY CORPORATION, Shanghai (CN)

(21) Appl. No.: 13/794,880

(22) Filed: Mar. 12, 2013

(30) Foreign Application Priority Data
Nov. 30, 2012 (CN) 201210507336.8

(51) Int. Cl. G06F 11/26

(52) U.S. Cl. CPC G06F 11/26
USPC 714/48

(57) ABSTRACT

A system and a method for testing sub-servers through a plurality of test phases are provided, in which a test process is defined to include a plurality of test phases; in each test phase, it is determined whether an error occurs in sub-servers; and when an error occurs in one sub-server, all tests are ended. Through such a technical means, the cost of the test of a multi-node server is reduced, and a technical efficacy of synchronously testing all the sub-servers in the multi-node server automatically is achieved.

### BACKGROUND OF THE INVENTION

1. Field of Invention

The present invention relates to a test system and a method thereof, and more particularly to a system and a method for testing sub-servers through a plurality of test phases.

2. Related Art

Due to the centralization trend of an information technology (IT) system and in consideration of cost, energy, and management, high-density configuration for data centers with a limited space becomes more and more common.

The so-called high-density configuration refers to that more IT apparatuses are placed in a certain space. In a data center, servers are often configured at a high density, so that the combined operational capability of the servers is greatly improved. Based on the demands for high-density configuration, a multi-node server emerges.

The multi-node server includes multiple nodes, and each node is a sub-server providing services independently. However, the nodes in the multi-node server share a power source and a cooling unit (for example, a fan), so the sub-servers cannot operate separately from the multi-node server.

Since the sub-servers cannot operate separately from the multi-node server, during the test of the multi-node server, it is infeasible to merely test a single sub-server, and instead it is required to test all sub-servers in the multi-node server.

In a test process of the multi-node server, the sub-servers in the multi-node server are completely tested one by one; merely after one sub-server passes the test, a next sub-server is tested. In this way, when subsequent sub-servers need to be tested, even if it is affirmed that no error occurs in preceding sub-servers, the subsequent sub-servers can be tested only after the tests of preceding sub-servers are finished, which increases the cost such as electric power and time consumed during the test.

To sum up, it can be known that the prior art has the problem that the cost of the test of the multi-node server is easily increased through the current process of testing the multi-node server at present. Therefore, it is necessary to provide a technical means for improvement to solve this problem.

### SUMMARY OF THE INVENTION

In view of the problem in the prior art that the cost of the test of the multi-node server is easily increased through the current process of testing the multi-node server, the present invention discloses a system and a method for testing sub-servers through a plurality of test phases.

The system for testing sub-servers through a plurality of test phases disclosed in the present invention is applied to a multi-node server, where the multi-node server includes a plurality of sub-servers. The system at least includes: a configuration data query module, used to query configuration data of pre-defined test phases, where the test phases have a predetermined test sequence; a test module, used to synchronously test the sub-servers according to the configuration data of the test phase performed according to the test sequence; and a flow control module, used to determine whether an error occurs in the sub-servers when the test module performs a test, and when an error occurs in one sub-server during the test, end all the tests performed by the test module on the sub-servers. The flow control module is further used to sequentially perform a next test phase when determining that the tests of all the sub-servers are finished, until all the test phases are finished.

The method for testing sub-servers through a plurality of test phases disclosed in the present invention is applied to a multi-node server, where the multi-node server includes a plurality of sub-servers. Steps of the method are as follows: querying configuration data of pre-defined test phases, where the test phases have a predetermined test sequence; synchronously testing the sub-servers according to the configuration data of one test phase to be performed; determining whether an error occurs in the sub-servers during the test, and when an error occurs in the sub-server during the test, ending all the tests of the sub-servers; and sequentially performing a next test phase when it is determined that the tests of all the sub-servers are finished, until all the test phases are finished.

The system and the method disclosed in the present invention are described above. Different from the prior art, in the preset invention, the test process is defined to be a plurality of test phases; in each test phase, it is determined whether an error occurs in the sub-servers; and when an error occurs in one sub-server, all the tests are ended, so as to solve the problem in the prior art, thereby achieving a technical effect of synchronously testing all the sub-servers in the multi-node server automatically.

### BRIEF DESCRIPTION OF THE DRAWINGS

The invention will become more fully understood from the detailed description given herein below illustration only, and thus is not limitative of the present invention, and wherein:

FIG. 1 is an architecture diagram of a system for testing sub-servers through a plurality of test phases according to the present invention.

FIG. 2 is a flow chart of a method for testing sub-servers through a plurality of test phases according to the present invention.

### DETAILED DESCRIPTION OF THE INVENTION

The present invention will be apparent from the following detailed description, which proceeds with reference to the accompanying drawings, wherein the same references relate to the same elements.

In the present invention, the conventional process of testing the multi-node server is divided into a plurality of test phases, and in each test phase, each sub-server in the multi-node server is tested. When an error occurs in a certain sub-server in any test phase, all the tests may be ended in advance without waiting till the tests of all sub-servers are finished.

The test phases mentioned in the present invention have a predetermined test sequence. Generally speaking, the test sequence of the test phases is defined by a designer who divides the conventional test process into multiple test phases, and as long as the test phases are performed according to the test sequence, a test process same as the conventional one can be completed.

The multi-node server mentioned in the present invention is a server including a plurality of sub-servers, where each sub-server in the multi-node server may provide services independently, but cannot operate separately from the multi-node server. The multi-node server may be, for example, a blade server or a “multi-birth server”, but the present invention is not limited thereto.

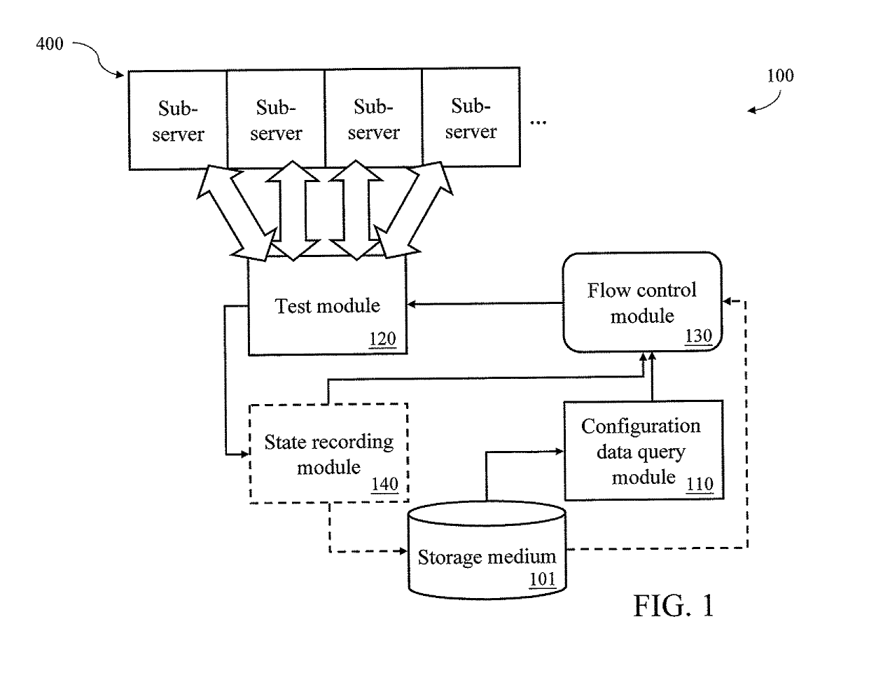

FIG. 1 is an architecture diagram of a system for testing sub-servers through a plurality of test phases according to the present invention. First, with reference to FIG. 1, the operation of the system in the present invention is described. As shown in FIG. 1, the system in the present invention includes a configuration data query module 110, a test module 120, a flow control module 130, and an addable state recording module 140.

The configuration data query module 110 is used to query configuration data of each test phase. The configuration data queried by the configuration data query module 110 includes the number of the sub-servers 400 included in the multi-node server 100, the number of test phases, and the test item of each test phase. In some embodiments, the configuration data may also include the test data of each test item, but the present invention is not limited thereto, and any data required in the test process may be the configuration data mentioned in the present invention.

The configuration data query module 110 may query the configuration data of each test phase in a storage medium 101 provided in the multi-node server 100, and may also query the configuration data of each test phase in an external storage device (not shown) through the multi-node server 100.

The test module 120 is controlled by the flow control module 130, and is used to synchronously test the sub-servers 400 in the multi-node server 100 according to the configuration data of each test phase.

In some embodiments, when the test in any test phase on a certain sub-server in the multi-node server 100 is finished, the test module 120 may acquire a test state of the sub-server whose test is finished, and then the state recording module 140 records the acquired test state of the sub-server. The test state mentioned in the present invention is state data capable of being monitored in the sub-server, including environmental parameters, network configuration, the use state of a processor, the use state of a memory, a voltage state, and the like, but the present invention is not limited thereto.

The flow control module 130 is used to extract configuration data of one test phase to be performed from the configuration data of the test phases that is queried by the configuration data query module 110, and provide the extracted configuration data to the test module 120, so that the test module 120 performs the test on each sub-server 400 in the multi-node server 100.

The flow control module 130 is further used to determine whether an error occurs in the sub-servers in the multi-node server 100 when the test module 120 performs the test, if an error occurs in any sub-server being tested by the test module 120, end all tests of the sub-server by the test module 120 and stop the tests of all the sub-servers the current time, and no longer continue to perform subsequent tests.

The flow control module 130 may constantly determine whether the test module 120 has finished the tests on all the sub-servers in the multi-node server 100, and when the test module 120 has not finished the tests on all the sub-servers, the flow control module 130 waits till the test module 120 has finished the tests on all the sub-servers. When determining that the test module 120 has finished the tests on all the sub-servers in the multi-node server 100, the flow control module 130 continues to perform a next test phase according to the test sequence of the test phases, until all the test phases are finished.

The flow control module 130 may search the storage medium 101 provided in the multi-node server 100 for a file recording the test state of each sub-server in the multi-node server 100, and determine whether the test states of all the sub-servers are recorded according to the content recorded in the found file; if yes, the flow control module 130 may determine that the tests of all the sub-servers are finished; and if the test state of one or more sub-servers is not recorded, determine that the test module 120 has not finished the tests on all the sub-servers. However, the manner for the flow control module 130 to determine whether the test module 120 has finished the tests on all the sub-servers is not limited to the foregoing description. For example, the flow control module 130 may also determine, according to a control signal returned from the test module 120, whether the test module 120 has finished the tests on all the sub-servers.

The state recording module 140 is used to record a test state generated after the test of each sub-server in the multi-node server 100 in each test phase is finished. Generally speaking, the state recording module 140 may record the test states obtained after the test module 120 has finished the test into the storage medium 101 provided in the multi-node server 100, but the present invention is not limited thereto. The state recording module 140 may also record the test states into another storage device (not shown) provided outside the multi-node server 100.

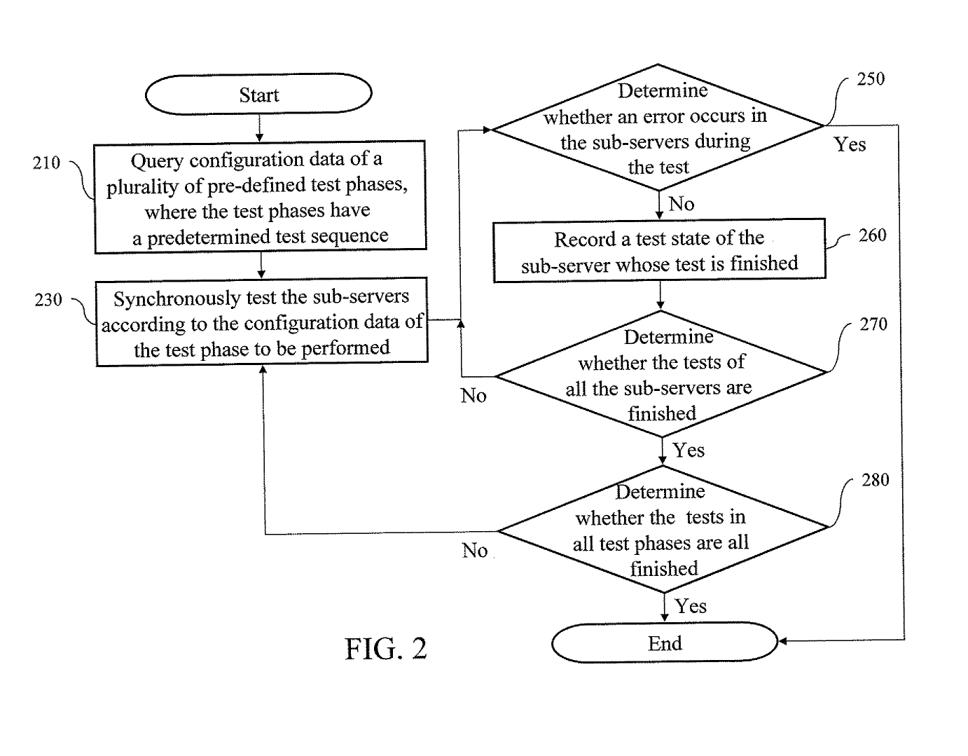

Then, with reference to an embodiment, an operating system and a method in the present invention are illustrated. Referring to FIG. 2, a flow chart of a method for testing sub-servers through a plurality of test phases according to the present invention is shown.

In this embodiment, if the multi-node server 100 is a “multi-birth server”, and the “multi-birth server” includes four sub-servers, which are indicated respectively as a first sub-server, a second sub-server, a third sub-server, and a fourth sub-server.

First, before the application of the present invention, it is first required to define a plurality of test phases according to a test process to be performed, and establish configuration data of each test phase.

If in this embodiment, two test phases are defined in total, and the configuration data of each test phase is stored in a storage medium 101 of the multi-node server 100, the configuration data query module 110 may query the configuration data of each test phase in the storage medium 101 (Step 210). For the convenience of description, the “first test phase” and the “second test phase” indicate the two test phases in this embodiment, where the “first test phase” precedes the “second test phase”.

After the configuration data query module 110 queries the configuration data of each test phase (Step 210), the flow control module 130 may provide, according to a test phase to be performed, configuration data of the test phase to be performed to the test module 120, so that the test module 120 may synchronously test the sub-servers in the multi-node server 100 (Step 230). In this embodiment, since it is about to test the multi-node server 100, the test phase to be performed by the flow control module 130 is the first test phase. Therefore, the flow control module 130 provides the configuration data of the first test phase to the test module 120, so that the test module 120 performs the tests on the sub-servers in the multi-node server 100 according to the configuration data of the first test phase, where it is assumed that the test module 120 performs the tests on the sub-servers in the same manner as that adopted in a conventional test of the same test item.

When the test module 120 performs the tests on the sub-servers in the multi-node server 100, the flow control module 130 may determine whether an error occurs in the sub-servers being tested when the test module 120 performs the test (Step 250); when the flow control module 130 determines that an error occurs in the sub-server when the test module 120 performs the test, it indicates that the test fails, and the flow control module 130 may end the test performed by the test module 120 on the sub-server, and stop all the subsequent tests to be performed on all the sub-servers.

If no error occurs in the sub-server when the test module 120 performs the test and the test module 120 has finished the test successfully, the test module 120 may record, by using the state recording module 140, a test state of the sub-server whose test is finished into the storage medium 101 provided in the multi-node server 100 (Step 260). If in this embodiment, the test module 120 performs the test according to a sequence of the first sub-server, the second sub-server, the third sub-server, and the fourth sub-server (but the present invention is not limited thereto), after the test in the first test phase on the first sub-server according to the configuration data of the first test phase is finished, the test module 120 may acquire a test state of the first sub-server, so that the state recording module 140 stores the test state of the first sub-server into the storage medium 101; then, the test module 120 may continue the test on the second sub-server, and after the test in the first test phase on the second sub-server is finished, the test module 120 provides the acquired test state of the second sub-server to the state recording module 140; and afterwards, the test module 120 continues the test on the third sub-server, and so on.

When the test module 120 performs the tests on the sub-servers of the multi-node server 100, the flow control module 130 may determine whether an error occurs in the sub-servers being tested when the test module 120 performs the test (Step 250), and may further continuously determine whether the test module 120 has finished the tests on all sub-servers (Step 270). In this embodiment, if the flow control module 130 determines whether the test module 120 has finished the tests on all sub-servers according to the test states of the sub-servers that are stored by the state recording module 140 in the storage medium 101, when the storage medium 101 has not stored the test states of all the sub-servers, for example, when the storage medium 101 has not stored the test states of the third sub-server and the fourth sub-server, the flow control module 130 determines that the test module 120 has not finished the tests on the third sub-server and the fourth sub-server, that is, has not finished the tests on all the sub-servers. Therefore, the flow control module 130 waits till the test module 120 has finished the tests on all the sub-servers. When the storage medium 101 has recorded the test states of all the sub-servers, the flow control module 130 may determine that the test module 120 has finished the tests on all the sub-servers.

After determining that the test module 120 has finished the tests on all the sub-servers, the flow control module 130 may further determine whether the tests in all test phases are finished (Step 280); if yes, end the current test; and otherwise, continue to perform the next test phase. Since there are two test phases in this embodiment in total, and the test module 120 has only finished the test in the first test phase, the flow control module 130 determines that the tests of all the test phases are not finished, turns to the next test phase, that is, the second test phase.

In the second test phase, the flow control module 130 repeats the process from Step 230 to Step 280, that is, provides the configuration data of the second test phase to the test module 120, so that the test module 120 synchronously tests the sub-servers in the multi-node server 100 (Step 230); meanwhile, the flow control module 130 determines whether an error occurs in the sub-servers when the test module 120 performs the test (Step 250).

Same as that in the first test phase, if the flow control module 130 determines that an error occurs in the sub-server when the test module 120 performs the test, it indicates that the test fails, and the flow control module 130 may end the test performed by the test module 120 on the sub-servers and stop various subsequent tests to be performed on all sub-servers by the test module 120. If no error occurs in the sub-server when the test module 120 performs the test and the test module 120 has successfully finished the test in the second test phase, the test module 120 may acquire the test state of the sub-server whose test is finished, and record, by using the state recording module 140, the acquired test state of the sub-server into the storage medium 101 provided in the multi-node server 100 (Step 260).

When the test module 120 performs the tests on the sub-servers in the multi-node server 100, the flow control module 130 may continuously determine whether the test module 120 has finished the tests on all the sub-servers (Step 270). After determining that the test module 120 has finished the tests on all the sub-servers, the flow control module 130 may further determine whether the tests of all the test phases are finished (Step 280). Since there are merely two test phases in this embodiment in total, and the test module 120 has finished the test in the second test phase at this time, the flow control module 130 may determine that the tests in all the test phases are finished, and end the current test.

In this way, through the present invention, it can be known in advance through test that an error occurs in a certain sub-server in the multi-node server without waiting till the entire test process on all the sub-servers in the multi-node server is finished, thereby saving the test time.

To sum up, the difference between the present invention and the prior art lies in that, the test process is defined to include a plurality of test phases, in each test phase, it is determined whether an error occurs in the sub-servers, and all the tests are ended when an error occurs in the sub-server; through such a technical means in the present invention, the problem in the prior art that the cost of the test of the multi-node server is easily increased through the current process of testing the multi-node server, thereby achieving a technical efficacy of synchronously testing all the sub-servers in the multi-node server automatically.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for testing sub-servers through a plurality of test phases, applied to a multi-node server, wherein the multi-node server comprises a plurality of sub-servers, and the method at least comprises the following steps:
querying configuration data of the plurality of pre-defined test phases, wherein the test phases have a predetermined test sequence;
synchronously testing the sub-servers according to the configuration data of one test phase to be performed;
determining whether an error occurs in the sub-servers during the test, and when an error occurs in one sub-server during the test, ending all tests of the sub-servers; and
sequentially performing a next test phase when determining that the tests of all the sub-servers are all finished, until the test phases are all finished

2. The method for testing sub-servers through a plurality of test phases according to claim 1, wherein after the step of determining whether an error occurs in the sub-server during the test, further comprising: when the test of one sub-server is finished, recording a test state of the sub-server whose test is finished.

3. The method for testing sub-servers through a plurality of test phases according to claim 1, wherein the determining whether the tests of the sub-servers are all finished is determining whether test states of the sub-servers are recorded, and when the test states of the sub-servers are all recorded, it indicates that the tests of the sub-servers are all finished.

4. The method for testing sub-servers through a plurality of test phases according to claim 1, wherein the determining whether the tests of the sub-servers are all finished further comprises: when determining that the test of one sub-server is not finished, waiting till the test of the sub-server whose test is not finished is finished.

5. A system for testing sub-servers through a plurality of test phases, applied to a multi-node server, wherein the multi-node server comprises a plurality of sub-servers, and the system at least comprises:
a configuration data query module, used to query configuration data of the predefined plurality of test phases, wherein the test phases have a predetermined test sequence;
a test module, used to synchronously test the sub-servers according to the configuration data of one of the test phase performed according to the test sequence;
a flow control module, used to determine whether an error occurs in the sub-servers when the test module performs a test, and when an error occurs in one sub-server during the test, ending all tests performed by the test module on the sub-servers;
wherein, the flow control module is further used to perform a next test phase when determining that the tests of the sub-servers are all finished, until all the test phases are finished.

6. The system for testing sub-servers through a plurality of test phases according to claim 5, wherein the system further comprises a state recording module, used to record test states of the sub-servers when the test module has finished the test.

7. The system for testing sub-servers through a plurality of test phases according to claim 5, wherein the flow control module determines whether the tests of the sub-servers are all finished according to whether the test states of the sub-servers are recorded.

8. The system for testing sub-servers through a plurality of test phases according to claim 5, wherein when determining that the test module has not finished the tests of the sub-servers, the flow control module waits till the test module has finished the tests of the sub-servers that are not finished.

9. The system for testing sub-servers through a plurality of test phases according to claim 5, wherein the multi-node server is a blade server.

10. The system for testing sub-servers through a plurality of test phases according to claim 5, wherein the multi-node server is a “multi-birth server”.
